(19) United States
(12) Patent Application Publication
(10) Pub. No.: US 2013/0003748 A1
(43) Pub. Date: Jan. 3, 2013

(54) RELAY APPARATUS AND RELAY CONTROL METHOD

(75) Inventors: Tooru ENOKI, Fukuoka (JP); Kenichi Ishii, Fukuoka (JP)

(73) Assignee: FUJITSU LIMITED, Kawasaki-shi (JP)

(21) Appl. No.: 13/475,277

(22) Filed: May 18, 2012

(30) Foreign Application Priority Data
Jul. 1, 2011 (JP) 2011-147049

(51) Int. Cl. H04L 12/56

(52) U.S. Cl. 370/401

(57) ABSTRACT

A relay apparatus includes: a receiver to receive a control message including a communication traffic amount of data sent from a first node on a first side; a total communication traffic amount notifying unit to calculate a total of communication traffic amounts included in a control message for each the first node and to notify a second node on a second side of a calculated total communication traffic amount; and an upper-limit communication traffic amount notifying unit to distribute a first upper-limit communication traffic amount of a line coupled to the second node or a second upper-limit communication traffic amount supplied from the second node in accordance with a proportion of a communication traffic amount included in the control message so as to determine a third upper-limit communication traffic amount of data transfer at the first node, and to notify the first node of the third upper-limit communication traffic amount.

### CROSS-REFERENCE TO RELATED APPLICATION(S)

This application is based upon and claims the benefit of priority of the prior Japanese Patent Application No. 2011-147049, filed on Jul. 1, 2011, the entire contents of which are incorporated herein by reference.

### FIELD

The embodiments discussed herein are related to a relay apparatus and a relay control method.

### BACKGROUND

In a Layer 2 (L2) network, L2 frames are transferred from a sender apparatus, such as a client apparatus, to a destination apparatus, such as a server apparatus, via a relay apparatus, such as an L2 switch or a router. If, for example, L2 frames having a data amount which exceeds the maximum transfer capacity of a line disposed subsequent to an L2 switch are input, the L2 switch may discard an excess amount of data and transfer the L2 frames within the maximum transfer capacity. Accordingly, in a line disposed prior to the L2 switch that discards an excess amount of data of the L2 frames, the transfer of the L2 frames to be discarded may influence the transfer of other L2 frames in the same line.

The related art is disclosed in, for example, Japanese Laid-open Patent Publication Nos. 2000-244501 and 2002-185465.

### SUMMARY

According to one aspect of the embodiments, a relay apparatus includes: a receiver to receive a control message including a communication traffic amount of data sent from a first node on a first side; a total communication traffic amount notifying unit to calculate a total of communication traffic amounts included in a control message for each the first node and to notify a second node on a second side of a calculated total communication traffic amount; and an upper-limit communication traffic amount notifying unit to distribute a first upper-limit communication traffic amount of a line coupled to the second node or a second upper-limit communication traffic amount supplied from the second node in accordance with a proportion of a communication traffic amount included in the control message so as to determine a third upper-limit communication traffic amount of data transfer at the first node, and to notify the first node of the third upper-limit communication traffic amount.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an exemplary discarding of a frame;

FIG. 2 illustrates an exemplary relay apparatus;

FIG. 3 illustrates exemplary information of a media access control (MAC) learning table;

FIG. 4 illustrates exemplary information of a bandwidth information table;

FIG. 5 illustrates exemplary information of an input traffic information table;

FIG. 6 illustrates exemplary information of a prior input traffic information table;

FIG. 7 illustrates an exemplary link layer discovery protocol (LLDP) message;

FIG. 8 illustrates an exemplary L2 network;

FIG. 9 illustrates sending and receiving of LLDP messages;

FIG. 10 illustrates an exemplary LLDP message sending process;

FIG. 11 illustrates an exemplary LLDP message sending process;

FIG. 12 illustrates an exemplary LLDP message reception process;

FIG. 13 illustrates an exemplary bandwidth information calculation process; and

FIG. 14 illustrates an exemplary frame relay process.

### DESCRIPTION OF EMBODIMENT

If L2 frames to be discarded later in a subsequent L2 switch are discarded in a prior L2 switch, the influence on the transfer of other L2 frames which use the same line may be reduced. For example, a prior L2 switch may be notified of the maximum transfer capacity of a line disposed subsequent to the L2 switch, and the prior L2 switch may discard L2 frames equivalent to a data amount exceeding the maximum transfer capacity.

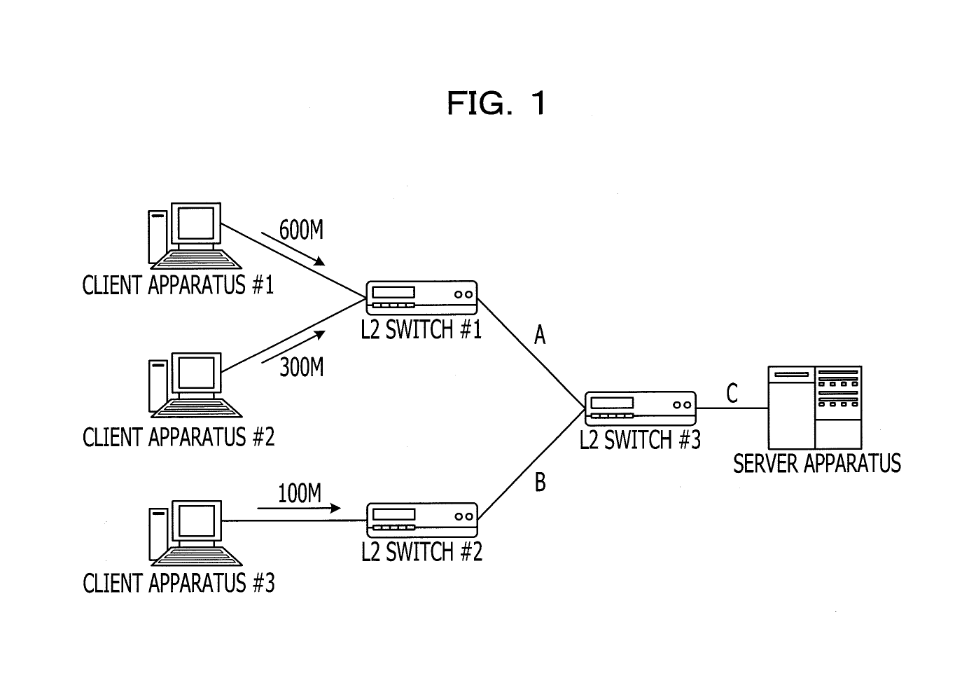

FIG. 1 illustrates an exemplary discarding frames. An L2 network includes client apparatuses #1, #2, and #3, L2 switches #1, #2, and #3, and a server apparatus. The client apparatuses #1 and #2 are coupled to the L2 switch #1, while the client apparatus #3 is coupled to the L2 switch #2. The L2 switches #1 and #2 are coupled to the L2 switch #3. The L2 switch #3 is coupled to the server apparatus.

For example, the client apparatus #1, #2, or #3 may send L2 frames to the server apparatus via the L2 switch #1, #2, or #3. A in FIG. 1 indicates a transfer rate of a line coupling the L2 switches #1 and #3. The transfer rate A may be, for example, 100 megabits per second (Mbps). B in FIG. 1 indicates a transfer rate of a line coupling the L2 switches #2 and #3. The transfer rate B may be, for example, 100 Mbps. C in FIG. 1 indicates a transfer rate of a line coupling the L2 switch #3 and the server apparatus. The transfer rate C may be, for example, 100 Mbps.

The client apparatus #1 may send L2 frames at, for example, 600 Mbps. The client apparatus #2 may send L2 frames at, for example, 300 Mbps. The client apparatus #3 may send L2 frames at, for example, 100 Mbps. Since the transfer rate of the line between the L2 switch #3 and the server apparatus is 100 Mbps, the L2 switch #3 informs each of the L2 switches #1 and #2 so that L2 frames are to be transferred with the upper limit of the transfer rate to 50 Mbps.

Upon receiving such information, the L2 switch #1 discards a number of L2 frames equivalent to 850 Mbps from a number of L2 frames equivalent to 900 Mbps, and transfers L2 frames at 50 Mbps to the L2 switch #3. Similarly, upon receiving such information, the L2 switch #2 discards a number of L2 frames equivalent to 50 Mbps from a number of L2 frames equivalent to 100 Mbps, and transfers L2 frames at 50 Mbps to the L2 switch #3. The L2 switch #3 transfers L2 frames at 100 Mbps as a total of L2 frames at 50 Mbps transferred from the L2 switch #1 and L2 frames at 50 Mbps transferred from the L2 switch #2 to the server apparatus. In this manner, because of a restriction on the traffic amount of a midway route, lines which relay L2 frames may effectively be utilized.

If, regardless of the amounts of data sent from sender apparatuses, data is simply discarded in advance depending on the maximum transfer capacity of a line coupled to a destination apparatus, the amount of transfer data may not become even. For example, the L2 switch #1 illustrated in FIG. 1 discards the L2 frames sent from the client apparatus #1 and the L2 frames from the client apparatus #2, and transfers the resulting L2 frames at 50 Mbps to the L2 switch #3. In this case, the L2 switch #1 may transfer L2 frames without considering the ratio of “2:1” of the transfer rate of the client apparatus #1 to that of the client apparatus #2.

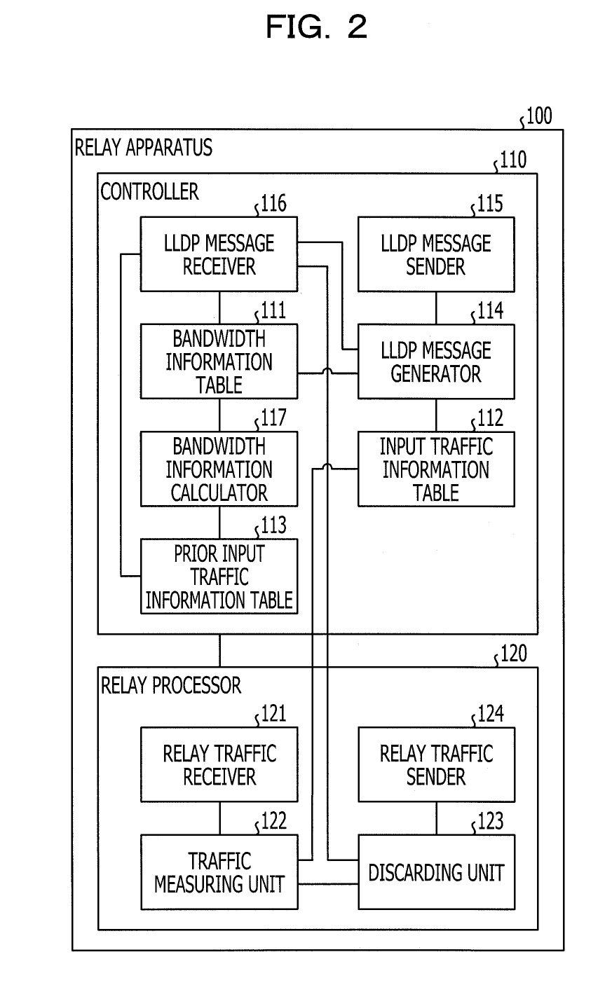

FIG. 2 illustrates an exemplary relay apparatus 100. The relay apparatus 100 includes a controller 110 and a relay processor 120. The relay apparatus 100 may be a communication apparatus, e.g., an L2 switch, that transfers data sent from a sender apparatus, e.g., a client apparatus, to a destination apparatus, e.g., a server apparatus.

The controller 110 executes a process, for example, concerning control messages communicated among relay apparatuses. The controller 110 includes a bandwidth information table 111, an input traffic information table 112, and a prior input traffic information table 113. The controller 110 also includes a link layer discovery protocol (LLDP) message generator 114, an LLDP message sender 115, an LLDP message receiver 116, and a bandwidth information calculator 117. The controller 110 may include a central processing unit (CPU). The CPU may execute a program stored in a memory.

The relay processor 120 executes a process, for example, concerning data transferred among relay apparatuses. The relay processor 120 includes a relay traffic receiver 121, a traffic measuring unit 122, a discarding unit 123, and a relay traffic sender 124. The relay processor 120 may include a CPU. The CPU may execute a program stored in a memory.

The relay apparatus 100 may include a media access control (MAC) learning table storing therein MAC addresses of sender apparatuses and reception ports included in received frames. Accordingly, when receiving a frame having a MAC address stored in the MAC learning table as a destination from another port, the relay apparatus 100 may transfer the frame to the port which has been learned, instead of transferring the frame to all the ports, which may reduce a wasteful amount of traffic. The relay apparatus 100 may include a configuration definition information table storing therein apparatus configuration information or line speed information concerning the speeds of lines coupled to the individual ports.

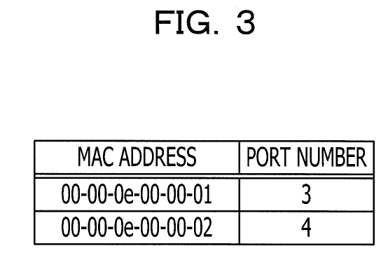

FIG. 3 illustrates exemplary information stored in a MAC learning table. The MAC learning table may store therein a MAC address “00-00-0e-00-00-01” and a port number “3” in association with each other. The MAC learning table may store therein a MAC address “00-00-0e-00-00-02” and a port number “4” in association with each other.

The bandwidth information table 111 may store therein MAC addresses of destination apparatuses to which data is transferred, such as server apparatuses, transmission ports, and upper-limit bandwidths of data when data is transferred by using lines coupled to the transmission ports, in association with one another.

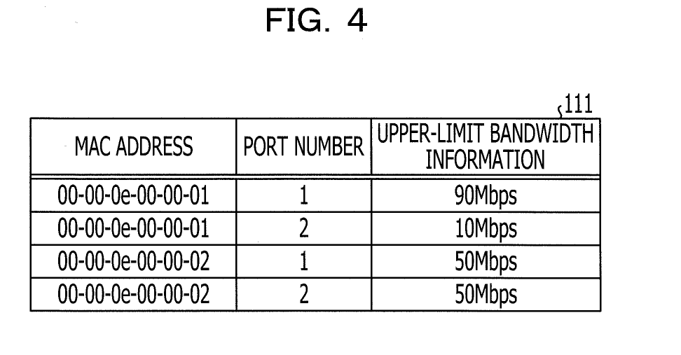

FIG. 4 illustrates exemplary information stored in a bandwidth information table 111. The bandwidth information table 111 may store, for example, a MAC address “00-00-0e-00-00-01”, port number “1”, and upper-limit bandwidth information “90 Mbps” in association with one another. The bandwidth information table 111 may store, for example, the MAC address “00-00-0e-00-00-01”, port number “2”, and upper-limit bandwidth information “10 Mbps” in association with one another. The bandwidth information table 111 may store, for example, the MAC address “00-00-0e-00-00-02”, port number “1”, and upper-limit bandwidth information “50 Mbps” in association with one another. The bandwidth information table 111 may store, for example, the MAC address “00-00-0e-00-00-02”, port number “2”, and upper-limit bandwidth information “50 Mbps” in association with one another.

The input traffic information table 112 may store therein MAC addresses of destination apparatuses to which data is transferred, such as server apparatuses, and traffic amounts of transfer data items having the MAC addresses input into the relay apparatus 100 as destinations.

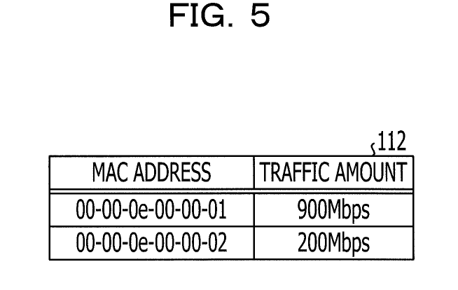

FIG. 5 illustrates exemplary information stored in an input traffic information table 112. The input traffic information table 112 may store therein a MAC address “00-00-0e-00-00-01” and a traffic amount “900 Mbps” in association with each other. The input traffic information table 112 may store therein a MAC address “00-00-0e-00-00-02” and a traffic amount “200 Mbps” in association with each other.

The prior input traffic information table 113 may store therein MAC addresses, port numbers, and traffic amounts in association with one another. The MAC address may be the MAC address of a destination apparatus to which data to be input into a relay apparatus which is disposed on an upstream side one prior to the relay apparatus 100 is transferred. The port number may be the reception port of the relay apparatus 100. The traffic amount may be the traffic amount of transfer data to be input into the relay apparatus disposed on the upstream side one prior to the relay apparatus 100.

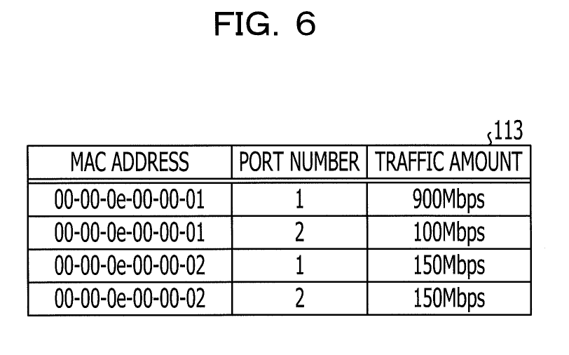

FIG. 6 illustrates exemplary information stored in a prior input traffic information table 113. The prior input traffic information table 113 may store therein a MAC address “00-00-0e-00-00-01”, a port number “1”, and a traffic amount “900 Mbps” in association with one another. The prior input traffic information table 113 may store therein a MAC address “00-00-0e-00-00-01”, a port number “2”, and a traffic amount “100 Mbps” in association with one another. The prior input traffic information table 113 may store therein a MAC address “00-00-0e-00-00-02”, a port number “1”, and a traffic amount “150 Mbps” in association with one another. The prior input traffic information table 113 may store therein a MAC address “00-00-0e-00-00-02”, a port number “2”, and a traffic amount “150 Mbps” in association with one another.

The LLDP message generator 114 generates an LLDP message including a bandwidth notification indicating the bandwidth of data to be transferred by another relay apparatus or an input amount notification indicating a traffic amount of transfer data input into the relay apparatus 100.

Concerning the bandwidth notification, the LLDP message generator 114 obtains a MAC address from the MAC learning table associated with a certain target port. The LLDP message generator 114 also obtains the line speed of a line coupled to the target port from the configuration definition information table, and obtains the upper-limit bandwidth information associated with the obtained MAC address from the bandwidth information table 111. The LLDP message generator 114 sets, as the bandwidth notification, the smaller value of the obtained line speed and the obtained the upper-limit bandwidth information. The LLDP message generator 114 generates an LLDP message including the MAC address of the destination apparatus and the bandwidth notification.

Concerning the input amount notification, the LLDP message generator 114 obtains the traffic amount associated with the MAC address of the destination apparatus from the input traffic information table 112. The LLDP message generator 114 sets the obtained traffic amount as the input amount notification. The LLDP message generator 114 generates an LLDP message including the MAC address of the destination apparatus and the input amount notification. Upon receiving an input amount notification from the LLDP message receiver 116, the LLDP message generator 114 calculates a total of input amounts indicated in the input amount notification, and generates an LLDP message including the MAC address of the destination address and the input amount notification.

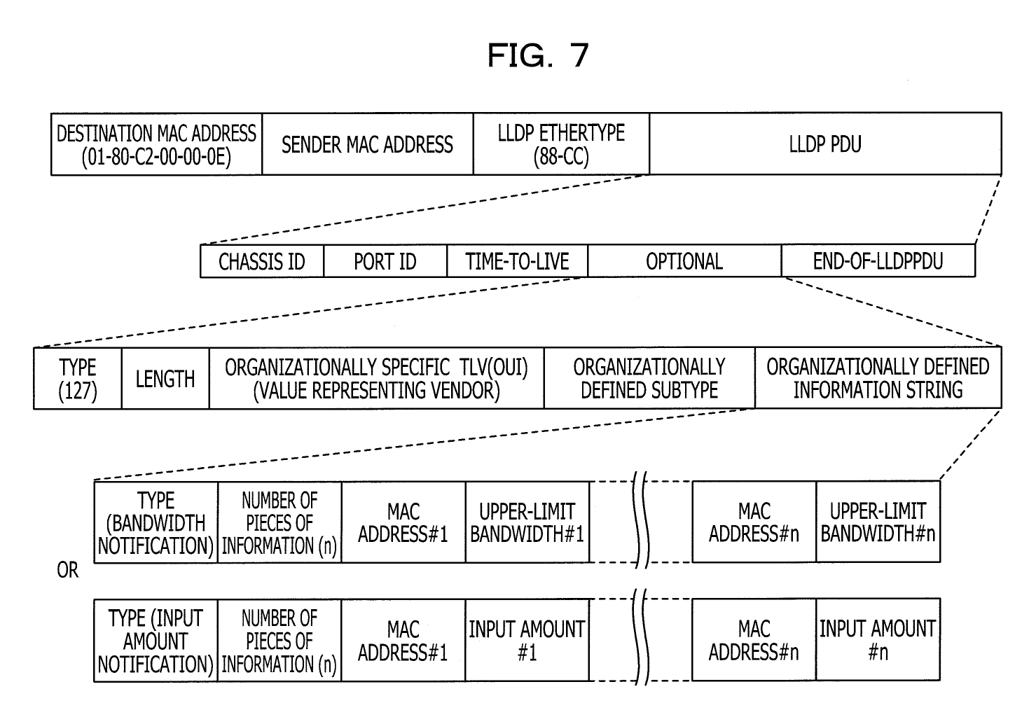

FIG. 7 illustrates an exemplary LLDP message. The format of the LLDP message illustrated in FIG. 7 includes, for example, a destination MAC address, a sender MAC address, LLDP Ethertype, and LLDP Protocol Data Unit (PDU).

For example, the destination MAC address may include a multicast MAC address of, for example, a server, which serves as a destination apparatus which receives transfer data. The sender MAC address may include a MAC address of, for example, an L2 switch, which serves as a sender apparatus which sends transfer data. LLDP Ethertype may include information indicating the type of communication protocol. LLDP PDU may be a data unit of the LLDP in which transfer data is stored.

LLDP PDU illustrated in FIG. 7 includes “Chassis ID”, “Port ID”, “Time-to-Live”, “Optional”, and “End-of-LLDPPDU”. “Chassis ID” may be information for identifying a machine, and may include an identifier for identifying a machine, a MAC address, or an Internet Protocol (IP) address. “Port ID” may be information indicating a port identifier, and may include an interface number or a port number. “Time-to-Live” may include a validity period of information stored in a frame. “End-of-LLDPPDU” may include information indicating the termination of LLDPPDU. “Optional” may include fields, such as “Type”, “Length”, and “Value”. “Value” includes three fields illustrated in FIG. 7. In the field of “Organizationally defined information string”, information including a bandwidth notification or an input amount notification is stored.

An LLDP message including a bandwidth notification includes a notification type (bandwidth notification), the number of pieces of information, the MAC address, and the upper-limit bandwidth. An LLDP message including an input amount notification includes a notification type (input amount notification), the number of pieces of information, the MAC address, and the traffic amount (input amount). The LLDP message generator 114 executes process for generating an LLDP message for each port at regular time intervals.

The LLDP message sender 115 illustrated in FIG. 2 sends, for example, an LLDP message generated by the LLDP message generator 114, to a port of another relay apparatus. The LLDP message sender 115 sends an LLDP message including a bandwidth notification to another relay apparatus from a port other than a target port. The LLDP message sender 115 sends an LLDP message including an input amount notification to another apparatus from the target port.

The LLDP message receiver 116 receives, for example, an LLDP message including a bandwidth notification or an input amount notification, from another relay apparatus. If, for example, the notification type of a received LLDP message is a bandwidth notification, the LLDP message receiver 116 obtains a MAC address and a bandwidth notification (upper-limit bandwidth information) contained in the LLDP message, and records them in the bandwidth information table 111. The LLDP message receiver 116 also supplies the obtained MAC address and bandwidth notification to the discarding unit 123. The LLDP message receiver 116 sets the received bandwidth notification as a new line speed, and updates the configuration definition information table.

If, for example, the notification type of a received LLDP message is an input amount notification, the LLDP message receiver 116 obtains a MAC address and an input amount (traffic amount) contained in the LLDP message, and records them in the prior input traffic information table 113. The LLDP message receiver 116 also supplies the received input amount notification to the LLDP message generator 114. The LLDP message receiver 116 may execute the above-described process every time it receives an LLDP message.

The bandwidth information calculator 117 obtains a traffic amount from the prior input traffic information table 113 for, for example, every MAC address or every destination apparatus. The bandwidth information calculator 117 determines the proportion of the obtained traffic amounts, and calculates the upper-limit bandwidths based on the determined proportion and the upper-limit line speed of a line from the relay apparatus 100 to the destination apparatus. The upper-limit line speed of the line may be obtained from the configuration definition information table. The bandwidth information calculator 117 records the calculated upper-limit bandwidths in the bandwidth information table 111. The bandwidth information calculator 117 may execute the above-described process at regular time intervals.

The relay traffic receiver 121 receives, for example, L2 frames. The traffic measuring unit 122 measures the traffic speed of the L2 frames received by the relay traffic receiver 121 for, for example, every MAC address of a destination apparatus. The traffic measuring unit 12 records the measured traffic speed in the input traffic information table 112 as the traffic amount. The traffic measuring unit 122 also outputs L2 frames to the discarding unit 123.

The discarding unit 123 discards a number of L2 frames that exceeds the upper-limit bandwidth based on the bandwidth notification received from the LLDP message receiver 116, and inputs the remaining L2 frames into the relay traffic sender 124. The relay traffic sender 124 transfers the L2 frames received from the discarding unit 123 to, for example, another relay apparatus or a destination apparatus.

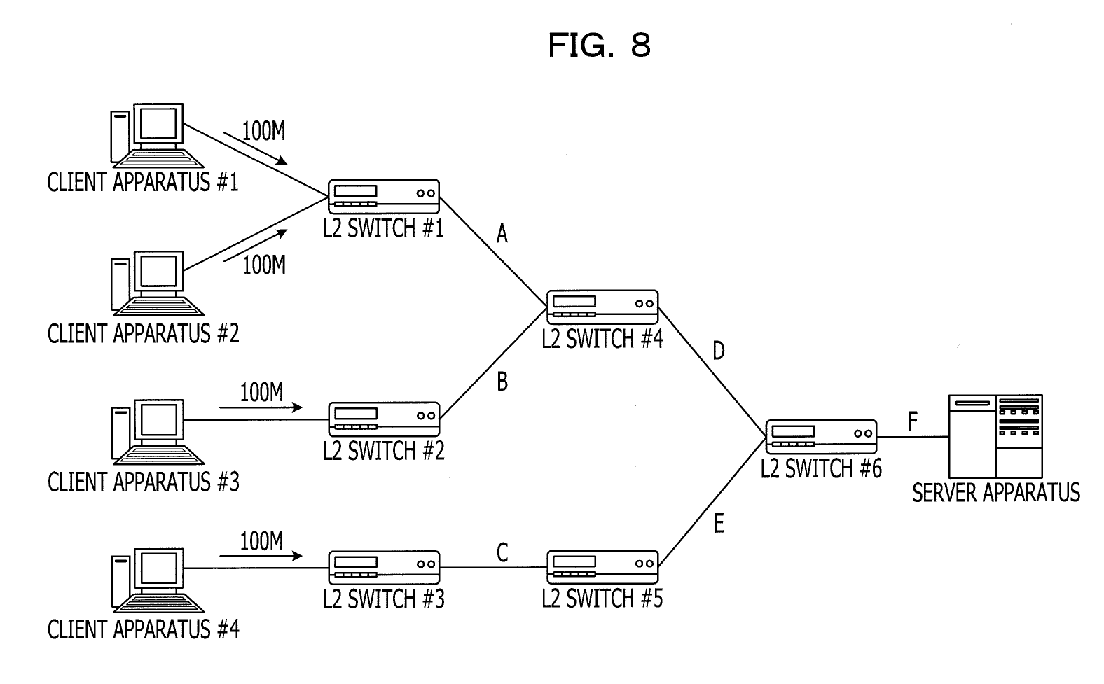

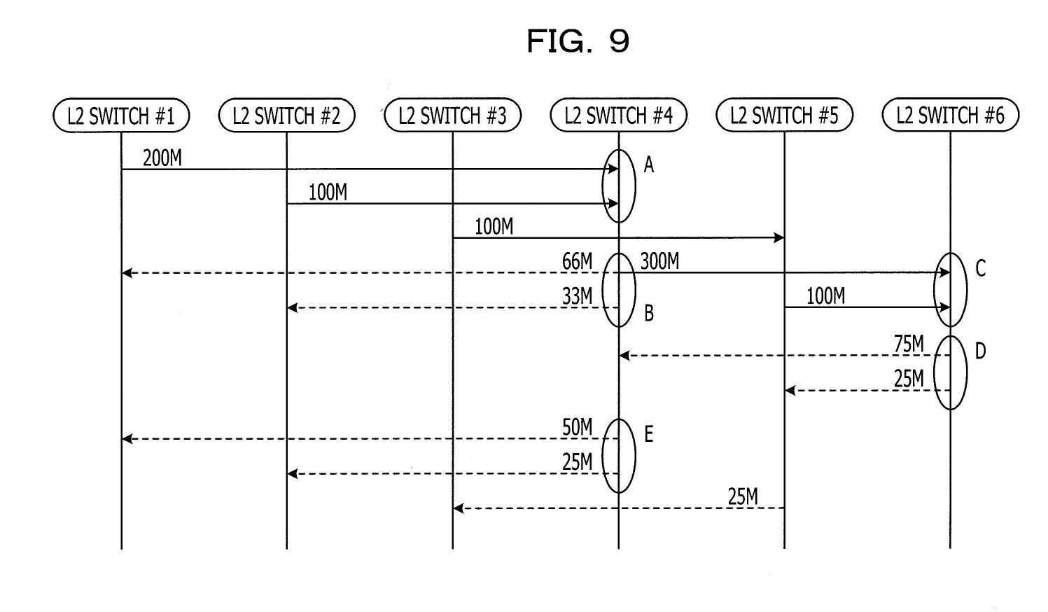

FIG. 8 illustrates an exemplary L2 network. The L2 network illustrated in FIG. 8 may send and receive LLDP messages. FIG. 9 illustrates an exemplary sending and receiving of LLDP messages. In FIGS. 8 and 9, the relay apparatus 100 may be an L2 switch. The solid line arrows illustrated in FIG. 9 indicate LLDP messages including input traffic amounts, while the dotted arrows illustrated in FIG. 9 indicate LLDP messages including bandwidth notifications.

The L2 network illustrated in FIG. 8 includes client apparatuses #1 through #4, L2 switches #1 through #6, and a server apparatus. The client apparatuses #1 and #2 are coupled to the L2 switch #1. The client apparatus #3 is coupled to the L2 switch #2. The client apparatus #4 is coupled to the L2 switch #3. The L2 switches #1 and #2 are coupled to the L2 switch #4. The L2 switch #3 is coupled to the L2 switch #5. The L2 switches #4 and #5 are coupled to the L2 switch #6. The L2 switch #6 is coupled to the server apparatus. The transfer rate of the lines A through F illustrated in FIG. 8 may be 100 Mbps. The client apparatuses #1 through #4 may send L2 frames at 100 Mbps.

The L2 switch #1 illustrated in FIG. 8 receives L2 frames at 100 Mbps from each of the client apparatuses #1 and #2. The L2 switch #1 adds information indicating that the total of input traffic amounts is 200 Mbps to an LLDP message, and supplies the LLDP message to the L2 switch #4. The L2 switch #2 receives L2 frames at 100 Mbps from the client apparatus #3. The L2 switch #2 adds information indicating that the input traffic is 100 Mbps to an LLDP message, and supplies the LLDP message to the L2 switch #4. The L2 switch #3 receives L2 frames at 100 Mbps from the client apparatus #4. The L2 switch #3 adds information indicating that the input traffic is 100 Mbps to an LLDP message, and supplies the LLDP message to the L2 switch #5.

The L2 switch #4 calculates a total of the input traffic amounts supplied from the L2 switches #1 and #2. The L2 switch #4 then adds information indicating that the input traffic is 300 Mbps to an LLDP message, and supplies the LLDP message to the L2 switch #6. In A illustrated in FIG. 9, upon receiving notifications about input traffic amounts from a plurality of L2 switches, the L2 switch #4 determines the proportion of input traffic amounts. For example, the L2 switch #4 determines the ratio of “200:100=2:1” of input traffic amount supplied from the L2 switch #1 and the L2 switch #2. The L2 switch #4 calculates upper-limit bandwidths based on the determined ratio and the upper-limit line speed of a line coupled to the L2 switch #6. For example, the L2 switch #4 calculates an upper-limit bandwidth “100 Mbps×(2/(2+1))=66 Mbps” corresponding to the L2 switch #1. The L2 switch #4 also calculates an upper-limit bandwidth “100 Mbps×(1/(2+1))=33 Mbps” corresponding to the L2 switch #2. The L2 switch #4 sends an LLDP message including the calculated upper-limit bandwidth to each of the L2 switches #1 and #2 in B illustrated in FIG. 9.

The L2 switch #5 adds information indicating that the input traffic is 100 Mbps to an LLDP message, based on the input traffic amount supplied from the L2 switch #3, and sends the LLDP message to the L2 switch #6. In C in FIG. 9, upon receiving notifications about input traffic amounts from a plurality of L2 switches, the L2 switch #6 determines the proportion of input traffic amounts. For example, the L2 switch #6 determines the ratio of “300:100=3:1” of input traffic amount supplied from the L2 switch #4 and the L2 switch #5. The L2 switch #6 calculates upper-limit bandwidths based on the determined ratio and the upper-limit line speed of a line coupled to the server apparatus. The L2 switch #6 calculates an upper-limit bandwidth “100 Mbps×(3/(3+1))=75 Mbps” corresponding to the L2 switch #4. The L2 switch #6 also calculates an upper-limit bandwidth “100 Mbps×(1/(3+1))=25 Mbps” corresponding to the L2 switch #5. The L2 switch #6 sends an LLDP message including the calculated upper-limit bandwidth to each of the L2 switches #4 and #5 in D illustrated in FIG. 9.

Upon receiving the LLDP message including the upper-limit bandwidth from the L2 switch #6, the L2 switch #4 calculates upper-limit bandwidths based on the ratio “2:1” of the input traffic amount supplied from the L2 switch #1 and the L2 switch #2 and the upper-limit bandwidth supplied from the L2 switch #6. The L2 switch #4 calculates an upper-limit bandwidth of “75 Mbps×(2/(2+1))=50 Mbps” corresponding to the switch L2 switch #1, and calculates an upper-limit bandwidth of “75 Mbps×(1/(2+1))=25 Mbps” corresponding to the L2 switch #2. In E illustrated in FIG. 8, the L2 switch #4 supplies an LLDP message including the determined upper-limit bandwidth to each of the L2 switches #1 and #2. Upon receiving the LLDP message from the L2 switch #6, the L2 switch #5 notifies the L2 switch #3 of the upper-limit bandwidth of “25 Mbps”.

The L2 switch #1 outputs L2 frames, which is input at 100 Mbps from each of the client apparatuses #1 and #2, to the L2 switch #4 at a distribution ratio of “25 Mbps” assigned to the client apparatus #1 to “25 Mbps” assigned to the client apparatus #2. The L2 switch #2 outputs L2 frames, which is input at 100 Mbps from the client apparatus #3, to the L2 switch #4 at “25 Mbps”. The L2 switch #3 outputs L2 frames, which is input at 100 Mbps from the client apparatus #4, to the L2 switch #5 at “25 Mbps”. The L2 switch #4 outputs the L2 frames input from the L2 switches #1 and #2 to the L2 switch #6 at “50 Mbps+25 Mbps=75 Mbps”. The L2 switch #5 outputs the L2 frames input from the L2 switch #3 to the L2 switch #6 at “25 Mbps”. The L2 switch #6 outputs the L2 frames input from the L2 switches #4 and #5 to the server apparatus at “75 Mbps+25 Mbps=100 Mbps”.

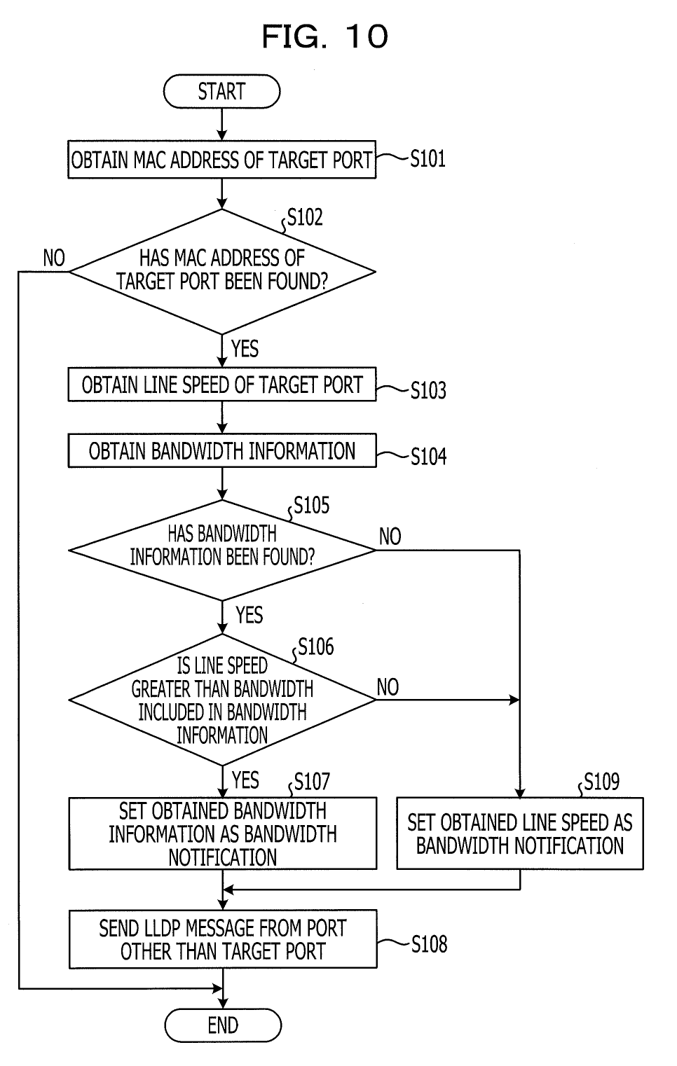

FIG. 10 illustrates an exemplary LLDP message sending process. An LLDP message may include a bandwidth notification.

In FIG. 10, in an operation S101, the LLDP message generator 114 obtains a MAC address from the MAC learning table associated with a certain target port. In an operation S102, the LLDP message generator 114 determines whether the MAC address of the target port is stored in the learning table. If the MAC address of the target port exists (i.e., if the result of the operation S102 is YES), the process proceeds to an operation S103. In the operation S103, the LLDP message generator 114 obtains the line speed of a line coupled to the target port from the configuration definition information table. If the MAC address of the target port does not exist (i.e., if the result of the operation S102 is NO), the LLDP message generator 114 terminates the process for the target port.

In an operation S104, the LLDP message generator 114 obtains upper-limit bandwidth information associated with the obtained MAC address from the bandwidth information table 111. In an operation S105, the LLDP message generator 114 determines whether upper-limit bandwidth information exists. If upper-limit bandwidth information exists (i.e., if the result of the operation S105 is YES), the LLDP message generator 114 determines in an operation S106 whether the line speed is greater than the upper-limit bandwidth indicated in the upper-limit bandwidth information.

If the line speed is greater than the upper-limit bandwidth indicated in the upper-limit bandwidth information (if the result of the operation S106 is YES), the process proceeds to an operation S107. In the operation S107, the LLDP message generator 114 generates an LLDP message including the obtained upper-limit bandwidth information as a bandwidth notification. If it is determined in the operation S105 that upper-limit bandwidth information does not exist (i.e., if the result of the operation S105 is NO), or if it is determined in the operation S106 that the line speed is not greater than the upper-limit bandwidth (i.e., if the result of the operation S106 is NO), the process proceeds to an operation S109. In the operation S109, the LLDP message generator 114 generates an LLDP message including the obtained line speed as a bandwidth in a bandwidth notification.

In an operation S108, the LLDP message sender 115 sends the LLDP message generated by the LLDP message generator 114 from a port other than the target port. For example, the LLDP message sender 115 sends an LLDP message including the upper-limit bandwidth information as a bandwidth notification to a corresponding port other than the target port. The LLDP message sender 115 sends an LLDP message including the line speed as a bandwidth in a bandwidth notification to a port other than the target port and other than the port to which the LLDP message including the upper-limit bandwidth information as a bandwidth notification has been sent. The above-described process may be executed for each port at regular time intervals.

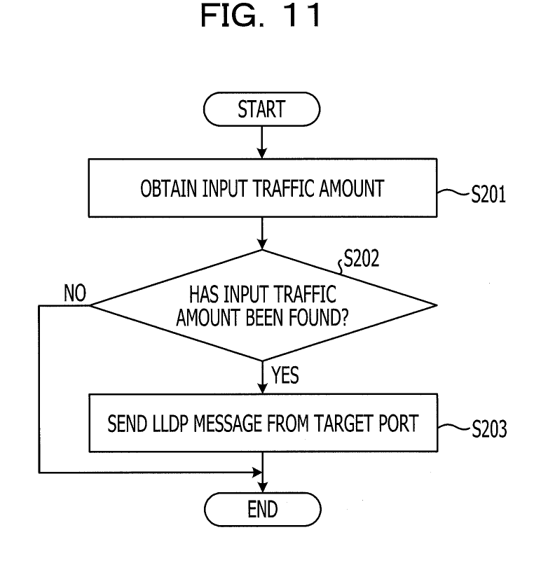

FIG. 11 illustrates an exemplary LLDP message sending process. An LLDP message may include an input amount notification.

In FIG. 11, in an operation S201, the LLDP message generator 114 obtains an input traffic amount associated with the MAC address of a destination apparatus from the input traffic information table 112. The LLDP message generator 114 determines in an operation S202 whether the input traffic amount exists.

If the input traffic amount has been found (i.e., if the result of operation S202 is YES), the LLDP message generator 114 generates an LLDP message including the obtained traffic amount as an input amount notification. If the input traffic amount exists (i.e., if the result of the operation S202 is NO), the LLDP message generator 114 terminates the process. In an operation S203, the LLDP message sender 115 sends the LLDP message generated by the LLDP message generator 114 from a target port.

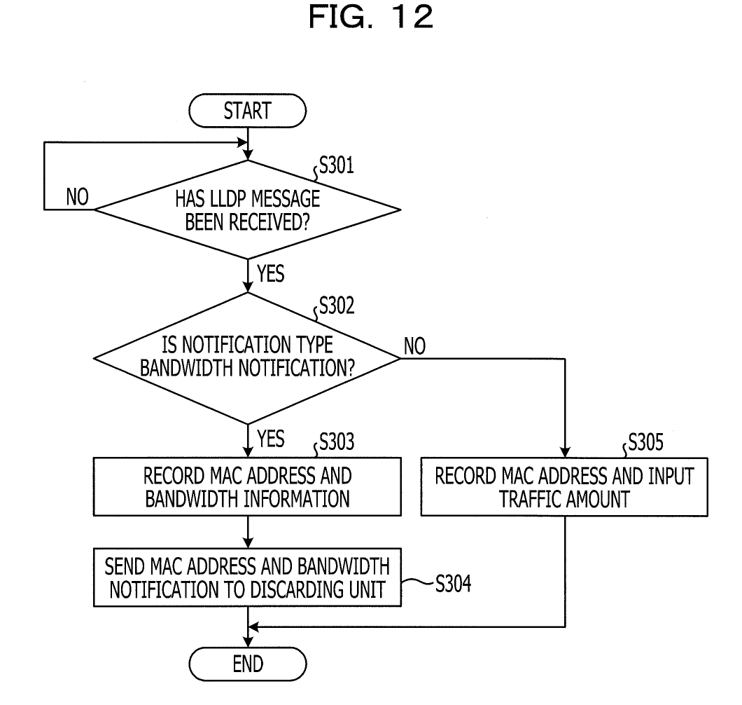

FIG. 12 illustrates an exemplary LLDP message reception process.

If an LLDP message has been received (if the result of an operation S301 is YES), the LLDP message receiver 116 determines in an operation S302 whether the notification type of the LLDP message is a bandwidth notification. If the notification type is a bandwidth notification (if the result of the operation S302 is YES), the process proceeds to an operation S303. In the operation S303, the LLDP message receiver 116 obtains a MAC address and a bandwidth notification contained in the LLDP message, and records them in the bandwidth information table 111. If an LLDP message has not been received (if the result of the operation S301 is NO), the LLDP message receiver 116 enters the standby state to wait for the reception of an LLDP message.

In an operation S304, the LLDP message receiver 116 sends the obtained MAC address and bandwidth notification to the discarding unit 123. If the notification type of the LLDP message is an input amount notification, the process proceeds to an operation S305. In the operation S305, the LLDP message receiver 116 obtains a MAC address and an input traffic amount contained in the LLDP message, and records them in the prior input traffic information table 113.

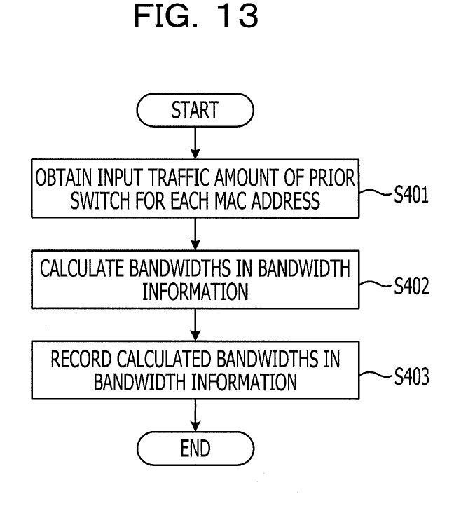

FIG. 13 illustrates an exemplary bandwidth information calculation process.

In an operation S401, the bandwidth information calculator 117 obtains a traffic amount for each MAC address from the prior input traffic information table 113. In an operation S402, the bandwidth information calculator 117 determines the proportion of the obtained traffic amounts, and calculates upper-limit bandwidths based on the determined proportion and the upper-limit line speed. In an operation S403, the bandwidth information calculator 117 records the calculated upper-limit bandwidths in the bandwidth information table 111.

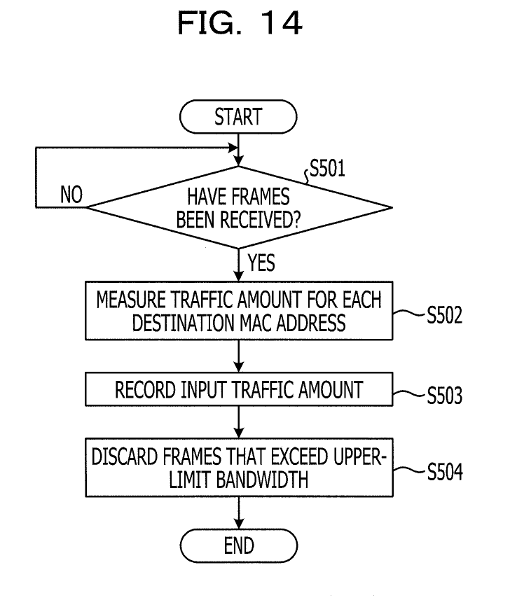

FIG. 14 illustrates an exemplary frame relay process.

If the relay traffic receiver 121 has received frames (the result of an operation S501 is YES), the traffic measuring unit 122 measures the traffic speed of the received frames in an operation S502. If the relay traffic receiver 121 has not receive any frame (i.e., the result of the operation S501 is NO), the relay traffic receiver 121 enters the standby state to wait for the reception of frames.

In an operation S503, the traffic measuring unit 122 records the measured traffic speed in the input traffic information table 112. In an operation S504, the discarding unit 123 discards frames equivalent to an amount that exceeds the upper-limit bandwidth based on the bandwidth notification supplied from the LLDP message receiver 116. The frames remaining as a result of discarding the excess frames by the discarding unit 123 are sent by the relay traffic sender 124.

The relay apparatus 100 adds the data amounts of data items sent from sender apparatuses and informs the total amount of data to other relay apparatuses including the final relay apparatus. The relay apparatus 100 determines the proportion of upper-limit bandwidths of the prior relay apparatuses based on the determined proportion of the amounts of data and the upper-limit line speed of a line through which the relay apparatus 100 transfers data. The relay apparatus 100 may transfer data with even data amounts.

The above-described operations, control operations, designation of components, information including data, parameters, etc., for example, the designation of the prior input traffic information table 113, may be changed as desired.

The components of the relay apparatus 100 may be functional components or physical components. The components may be divided or integrated as desired. For example, the components may be divided or integrated functionally or physically in every certain group of components, in accordance with various loads or the conditions for use. For example, the relay traffic receiver 121 and the traffic measuring unit 122 may be integrated as a traffic receiving/measuring unit that receives frames and measures traffic amounts.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A relay apparatus comprising:
a receiver to receive a control message including a communication traffic amount of data sent from a first node on a first side;
a total communication traffic amount notifying unit to calculate a total of communication traffic amounts included in a control message for each the first node and to notify a second node on a second side of a calculated total communication traffic amount; and
an upper-limit communication traffic amount notifying unit to distribute a first upper-limit communication traffic amount of a line coupled to the second node or a second upper-limit communication traffic amount supplied from the second node in accordance with a proportion of a communication traffic amount included in the control message so as to determine a third upper-limit communication traffic amount of data transfer at the first node, and to notify the first node of the third upper-limit communication traffic amount.

2. The relay apparatus according to claim 1, wherein the upper-limit communication traffic amount notifying unit distributes the second upper-limit communication traffic amount in accordance with the proportion of the communication traffic amount if being notified of the second upper-limit communication traffic amount by the second node, and the upper-limit communication traffic amount notifying unit distributes the first upper-limit communication traffic amount in accordance with the proportion of the communication traffic amount included in the control message if being notified of the second upper-limit communication traffic amount by the second node.

3. The relay apparatus according to claim 1, further comprising:
a transmitter to transmit a control message including a communication traffic amount of data to be sent from the relay apparatus to the second node,
wherein the transmitter adjusts an amount of data to be sent based on the second upper-limit communication traffic amount if being notified of the third upper-limit communication traffic amount by the second node.

4. The relay apparatus according to claim 1, wherein the first node is positioned on an upstream side, and the second node is positioned on a downstream side.

5. A relay control method, comprising:
receiving, by a computer, a control message including a communication traffic amount of data sent from a first node on a first side;
calculating a total of communication traffic amount included in a control message for each of the first node and notifying a second node on a second side of the calculated total communication traffic amount; and
distributing a first upper-limit communication traffic amount of a line coupled to the second node or a third upper-limit communication traffic amount supplied from the second node in accordance with a proportion of a communication traffic amount included in the control message so as to determine a third upper-limit communication traffic amount of data transfer from the first node, and notifying the first node of the third upper-limit communication traffic amount.

6. The relay control method according to claim 5, further comprising:
distributing the second upper-limit communication traffic amount in accordance with the proportion of the communication traffic amount included in the control message if the second upper-limit communication traffic amount is supplied from the second node; and
distributing the first upper-limit communication traffic amount in accordance with the proportion of the communication traffic amount included in the control message if the second upper-limit communication traffic amount is not supplied from the second node.

7. The relay control method according to claim 5, further comprising, adjusting an amount of data to be sent based on the second upper-limit communication traffic amount.

8. The relay control method according to claim 5, wherein the first node is positioned on an upstream side, and the second node is positioned on a downstream side.
